(19) United States
(12) Patent Application Publication
(10) Pub. No.: US 2016/0042282 A1
(43) Pub. Date: Feb. 11, 2016

(54) RELATIONSHIP EVALUATOR

(71) Applicant: Rashied Baradaran Amini, St. Louis, MO (US)

(72) Inventor: Rashied Baradaran Amini, St. Louis, MO (US)

(21) Appl. No.: 14/578,419

(22) Filed: Dec. 20, 2014

Related U.S. Application Data
(60) Provisional application No. 62/036,068, filed on Aug. 11, 2014.

(51) Int. Cl. G06N 5/04

(52) U.S. Cl. CPC G06N 5/04

(57) ABSTRACT

Among other things, one or more systems and/or techniques for determining one or more relationship suggestions and/or predictions based upon one or more relationship values are provided herein. One or more user inputs received from at least one user, simulation, and/or population may be used to determine safe and/or acceptable matches. Based upon one or more safe matches corresponding to a preferred level of compatibility and/or one or more acceptable matches corresponding to an adequate level of compatibility, one or more time dependent values may be generated using one or more functions (e.g., the partition function) and factors (e.g., rigidity, depreciation, and/or people met and/or relationships made per time period). The one or more relationship values may be used to determine one or more relationship suggestions and/or predictions.

### RELATED APPLICATION

This application corresponds to U.S. Application No. 62/036,068, filed on Aug. 11, 2014, entitled “PROCESS FOR DETERMINING COST-BENEFIT OF LONG-TERM ROMANTIC OPTIONS,” at least some of which may be incorporated herein.

### BACKGROUND

Matchmaking services, particularly those that are online, are growing in popularity. Considerable work has been done to create personality exams that match people together based upon results of psychometric evaluation. However, existing services for matchmaking often merely consider single users and identify potential matches between people who have not yet even met.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques are described herein for determining one or more values for one or more relationships. Data corresponding to a first user may be received. Data corresponding to a second user may be received. Data corresponding to a population of users may be received, where the population of users may comprise one or more users other than the first user and the second user. A first value corresponding to a relationship between the first user and the second user may be determined based upon the data corresponding to the first user, the data corresponding to the second user and the data corresponding to the population of users.

In another embodiment, a first variable corresponding to a characteristic of a first user may be determined. A second variable corresponding to a characteristic of a second user may be determined. A first value may be determined based upon a function using the first variable and the second variable, where the first value may correspond to a relationship between the first user and a second user, and where the first user may be one of the same as or different than the second user.

In another embodiment, data corresponding to a first user may be received. Data corresponding to a second user may be received. Data corresponding to a population of users may be received, where the population of users may comprise one or more users other than the first user and the second user. A first value corresponding to a relationship between the first user and the second user may be determined based upon the data corresponding to the first user, the data corresponding to the second user and the data corresponding to the population of users.

The following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary method for determining one or more relationship values.

FIG. 2 is an illustration of an exemplary system for determining one or more relationship suggestions and/or one or more relationship predictions.

FIG. 3 is an illustration of an exemplary graphical representation associated with one or more relationship values.

FIG. 4 is an illustration of an exemplary graphical representation associated with one or more relationship values.

FIG. 5 is an illustration of an exemplary graphical representation associated with one or more relationship values.

FIG. 6 is an illustration of an exemplary graphical representation associated with one or more relationship values.

FIG. 7 is an illustration of an exemplary graphical representation associated with one or more relationship values.

FIG. 8 is an illustration of an exemplary method for determining one or more relationship suggestions and/or one or more relationship predictions.

FIG. 9 is an illustration of an exemplary user interface.

FIG. 10 is an illustration of an exemplary user interface.

FIG. 11 is an illustration of an exemplary user interface.

FIG. 12 is an illustration of an exemplary system for determining data corresponding to one or more users.

FIG. 13 is an illustration of an exemplary computer-readable medium wherein processor-executable instructions configured to embody one or more of the provisions set forth herein may be comprised.

FIG. 14 illustrates an exemplary computing environment wherein one or more of the provisions set forth herein may be implemented.

FIG. 15 is an illustration of an exemplary method.

FIG. 16 is an illustration of groups.

FIG. 17 is an illustration of an exemplary graphical representation corresponding to a probability of finding a match for a user.

FIG. 18 is an illustration of an exemplary graphical representation corresponding to a group breakdown of match probability.

FIG. 19 is an illustration of an exemplary graphical representation corresponding to assessed average trait penalty.

FIG. 20 is an illustration of an exemplary graphical representation of cumulative value of relationship options in time.

FIG. 21 is an illustration of an exemplary graphical representation of cumulative value of relationship options in time.

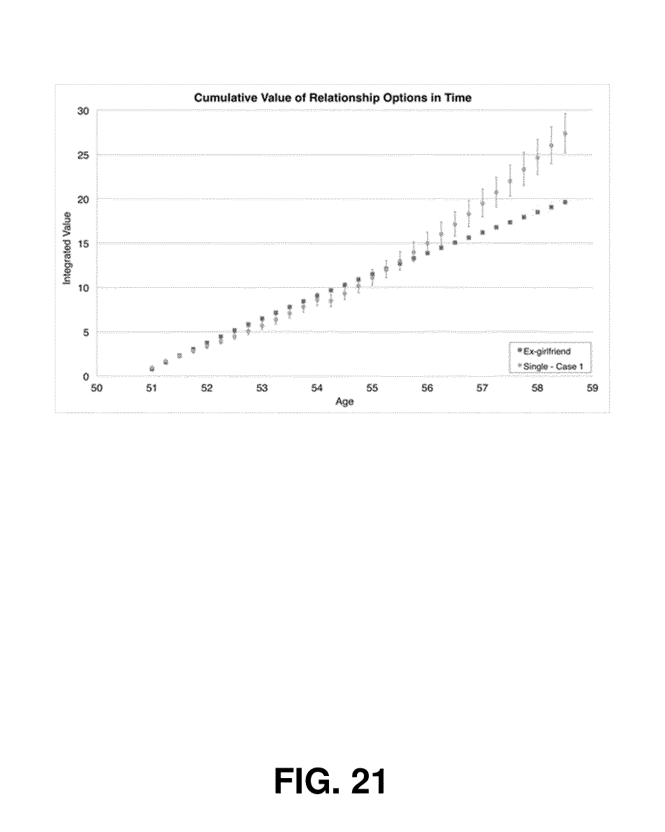

FIG. 22 is an illustration of a function.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

A relationship value may indicate and/or be used to determine a relationship suggestion. For example, based upon the relationship value, a suggestion that a first person disengage from a personal relationship with a second person may be made. In another example, the relationship value may be used to make a suggestion that the first person continue to engage in the personal relationship with the second person. In some instances, the relationship value may be used to make a suggestion that the first person engage in a personal relationship with a third person with whom the first person has not engaged in a personal relationship (e.g., prior to the suggestion).

In some instances, the relationship value may indicate and/or be used to determine a prediction. For example, the relationship value may be used to predict a time (e.g., in the future) at which the first person may disengage from a personal relationship with the second person. In another example, a relationship value may be used to predict a time at which the first person may continue to engage in a personal relationship with the second person. In some instances, the relationship value may be used to predict a time at which the first person may engage in a personal relationship with the third person with whom the first person has not engaged in a personal relationship.

A user may be representative information and/or content utilized to construct a profile of a first person or a second person. In one example, the user may be a person providing information representative of the person. In another example, the user may be a first person providing information and/or content representative of a second person. In some instances, the user may provide information and/or content representative of a simulated person. It may be appreciated that the simulated person may be determined utilizing the Monte Carlo method. In another example, the user may provide information and/or content of a population of persons. The population of persons may be information and/or content representative of two or more persons. In some instances, the user may provide information and/or content of at least one portion of a population of persons. For example, at least one portion of a population of persons may be representative of women whose ages range from 19 years old to 30 years old.

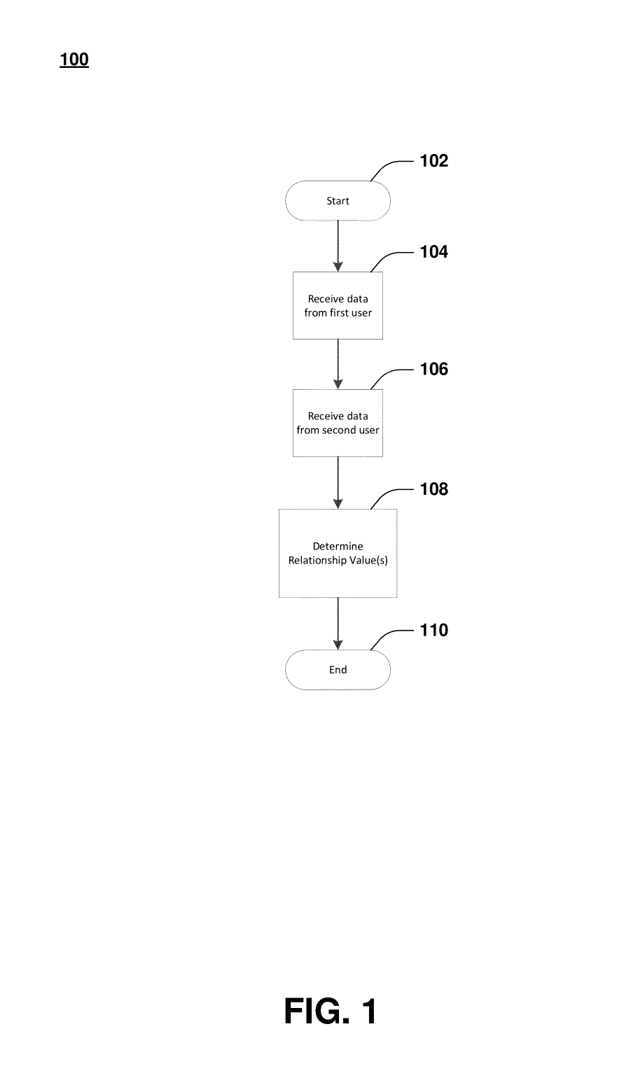

One embodiment of a method 100 of generating a relationship value is illustrated in FIG. 1. At 102, the method 100 starts. At 104, a first user input may be received. In one example, the first user input may correspond to and/or be received from a first user (e.g., a first person). The first user input, for example, may comprise data corresponding to and/or representative of the first user. At 106, a second user input may be received. In one example, the second user input may correspond to and/or be received from the first user, a second user (e.g., different than the first user) (e.g., a second person), a simulated person (e.g., generated by a Monte Carlo method), a population of users, and/or a portion of the population of users. The second user input, for example, may comprise data corresponding to and/or representative of the first user, the second user, the simulated user, the population of users and/or the portion of the population of users. At 108, a relationship value may be determined. The relationship value may be determined based upon at least the first user input and the second user input. In some embodiments, the relationship value may be determined based upon the first user input, the second user input, and third user input. The third user input may, for example, comprise data corresponding to and/or representative of the population of users and/or the portion of the population of users. At 110, the method 100 ends.

It may be appreciated that the portion of the population of persons may be associated with a population bias. In some instances, the portion of the population of persons utilized may be determined based upon the first user input (e.g., self-selection population bias).

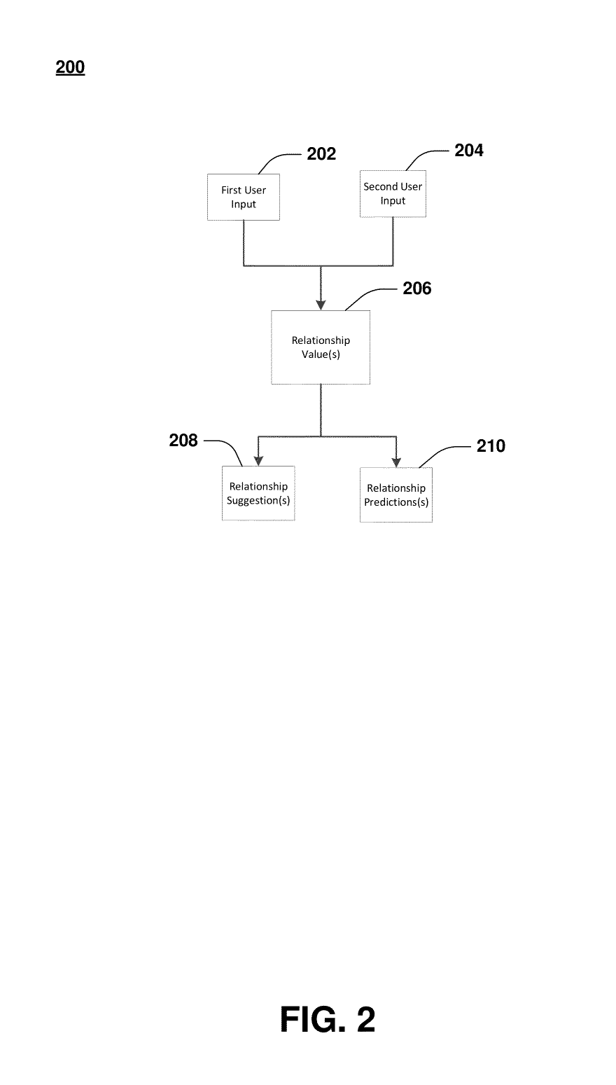

FIG. 2 illustrates an example of a system 200 for determining at least one relationship suggestion 208 and/or at least one relationship prediction 210, which may be determined based upon at least one relationship value 206. For example, the relationship suggestion 208 determined based upon the relationship value 206 may suggest that a first person should disengage from a relationship with a second person. In another example, the relationship prediction 210 determined based upon the relationship value 206 may predict a time at which a first person may engage in a relationship with a second person with whom the first person has not engaged in a relationship. The relationship value 206 may be based upon at least one a first user input 202 and/or a second user input 204. For example, the relationship value 206 may be based upon at least one user input which may correspond to a first person, a second person, and/or a third person. In another example, the relationship value 206 may be based upon a second user input which may correspond to a first simulated person, a second simulated person, and/or a third simulated person. In another example, the relationship value 206 may be based upon a third user input which may correspond to a first population of persons, a second population of persons, and/or a third population of persons.

It may be appreciated that a first user input and/or a second user input may comprise one or more components. For example, a first user input corresponding to a first user may comprise and/or indicate one or more components corresponding to and/or descriptive of the first user (e.g., the first user's sociability, the first user's intelligence, the first user's compassion, etc.). A window of compatibility may be information and/or content representative of the importance and/or a priority of at least one component of a user input. For example, the first user input e.g., may indicate the importance of a component (e.g., the importance of sociability, the importance of intelligence, the importance of compassion, etc.) to the first user. It may be appreciated that the second and/or one or more users may be associated with one or more components.

A component, for example, may represent one or more personality characteristics (e.g., an emotional temperament (e.g., self-awareness, emotional independence, emotional energy, obstreperousness, romantic passion, etc.), a social style (e.g., integrity, kindness, dominance, sociability, autonomy, practical adaptability, etc.), a cognitive mode (e.g., intellect, curiosity—in domain, curiosity—beyond domain, overlap of academic interest, level of humor, standard of humor, artistic passion, etc.), a physicality (e.g., physical energy, level of sexuality, standard of sexuality, vitality and security, industry, appearance, etc.), a relationship skill (e.g., communication ability, anger management, mood management, conflict resolution, etc.), an ethic (e.g., spirituality, religiosity, family goals, traditionalism, ambition, altruism, ethical adaptability, etc.), a belief, a key experience (e.g., emotionally healthy family background, physically healthy family background, exposure to ethnic diversity, exposure to intellectual diversity, level of education, etc.), etc.), demographic characteristics (a political view, a religion, an age, a gender, a race, a location, a career field, a level of education, a language, a culture, a financial status, a disability, a habit, etc.), and/or other characteristics.

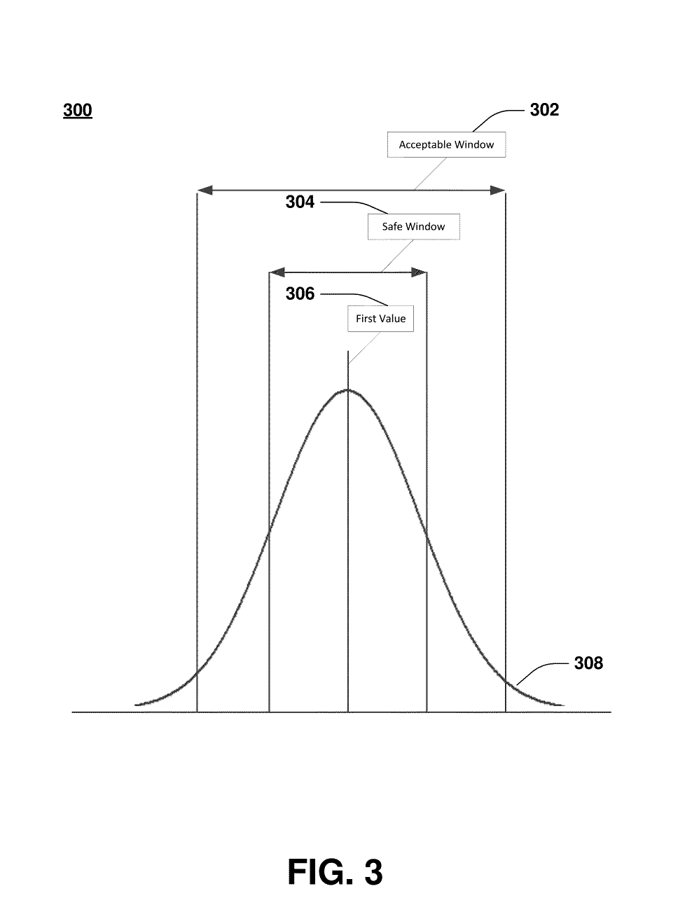

FIG. 3 illustrates an example of a graphical representation 300. A first value 306 may represent information and/or content indicative of at least one component corresponding to and/or descriptive of a user. For example, the first value 306 may be a numerical value which quantifies the component (e.g., a numerical value associated with the user's sociability, a numerical value associated with the user's intelligence, a numerical value associated with the user's compassion, etc.). A distribution 308 may represent a relationship of the at least one component for one or more users (e.g., a population of users). For example, the distribution 308 may be a normal distribution, a bimodal distribution, a skewed distribution, a binomial distribution, a geometric distribution, a Poisson distribution, an exponential distribution, a gama distribution, a beta distribution, a Bernoulli distribution, a chi-squared distribution and/or one or more other types of distributions. A window of compatibility may comprise, for example, a safe window 304 and/or an acceptable window 302. The safe window 304 may represent the importance and/or priority of the at least one component for the user (e.g., a first person's compassion) that indicates a preferred level of compatibility. For example, the safe window 304 may represent the user's indication that a particular (e.g., higher, lower, etc.) level and/or range of compassion is preferred (e.g., ideal). In some instances, the safe window 304 may be represented by at least a portion (e.g., some but not all, or all) of a standard score (e.g., a z-score) and/or a plurality of standard scores (e.g., a plurality of z-scores). The acceptable window 302 may represent the importance and/or priority of the at least one component for the user (e.g., a first person's compassion) that indicates an adequate (e.g., acceptable and/or “good enough”, but not necessarily ideal) level and/or range of compatibility. For example, the acceptable window 302 may represent the user's indication that a particular (e.g., higher, lower, etc.) level and/or range of compassion is adequate. In some instances, the acceptable window 302 may be represented by at least a portion of a standard score (e.g., a z-score) and/or a plurality of standard scores (e.g., a plurality of z-scores). The graphical representation 300 may comprise, for example, the safe window 304 representing a preferred level of compatibility which may be a standard score (e.g., z-score) and the acceptable window 302 representing an adequate level of compatibility which may be two (e.g., or more) standard scores (e.g., 2 z-scores).

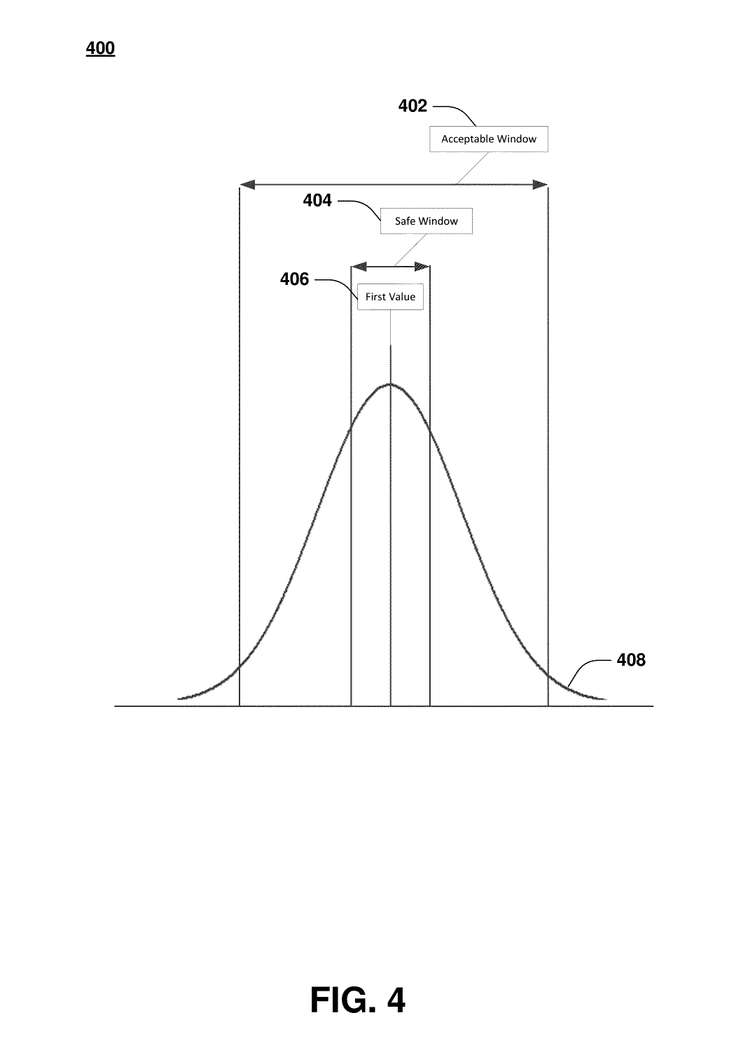

FIG. 4 illustrates an example of a graphical representation 400. A first value 406 may represent information and/or content indicative of at least one component corresponding to and/or descriptive of a user. For example, the first value 406 may be a numerical value which quantifies the component (e.g., a numerical value associated with the user's sociability, a numerical value associated with the user's intelligence, a numerical value associated with the user's compassion, etc.). A distribution 408 may represent a relationship of the at least one component for one or more users (e.g., a population of users). For example, the distribution 408 may be a normal distribution, a bimodal distribution, a skewed distribution, a binomial distribution, a geometric distribution, a Poisson distribution, an exponential distribution, a gamma distribution, a beta distribution, a Bernoulli distribution, a chi-squared distribution and/or one or more other types of distributions. A window of compatibility may comprise, for example, a safe window 404 and/or an acceptable window 402. The safe window 404 may represent the importance and/or priority of the at least one component for the user (e.g., a first person's compassion) that indicates a preferred level of compatibility. For example, the safe window 404 may represent the user's indication that a particular (e.g., higher, lower, etc.) level and/or range of compassion is preferred (e.g., ideal). In some instances, the safe window 404 may be represented by at least a portion (e.g., some but not all, or all) of a standard score (e.g., a z-score) and/or a plurality of standard scores (e.g., a plurality of z-scores). The acceptable window 402 may represent the importance and/or priority of the at least one component for the user (e.g., a first person's compassion) that indicates an adequate (e.g., acceptable and/or “good enough”, but not necessarily ideal) level and/or range of compatibility. For example, the acceptable window 402 may represent the user's indication that a particular (e.g., higher, lower, etc.) level and/or range of compassion is adequate. In some instances, the acceptable window 402 may be represented by at least a portion of a standard score (e.g., a z-score) and/or a plurality of standard scores (e.g., a plurality of z-scores). The graphical representation 400 may comprise, for example, the safe window 404 representing a preferred level of compatibility which may be (e.g., merely) a portion (e.g., but not all) of a standard score (e.g., a fraction of a z-score) and the acceptable window 402 representing an adequate level of compatibility which may be two (e.g., or more) standard scores (e.g., 2 z-scores). The safe window 404 may, for example, represent an increased importance and/or priority of the at least one component for the user (e.g., the first person's compassion) that indicates an increased preferred level of compatibility relative to the safe window 304 illustrated in FIG. 3.

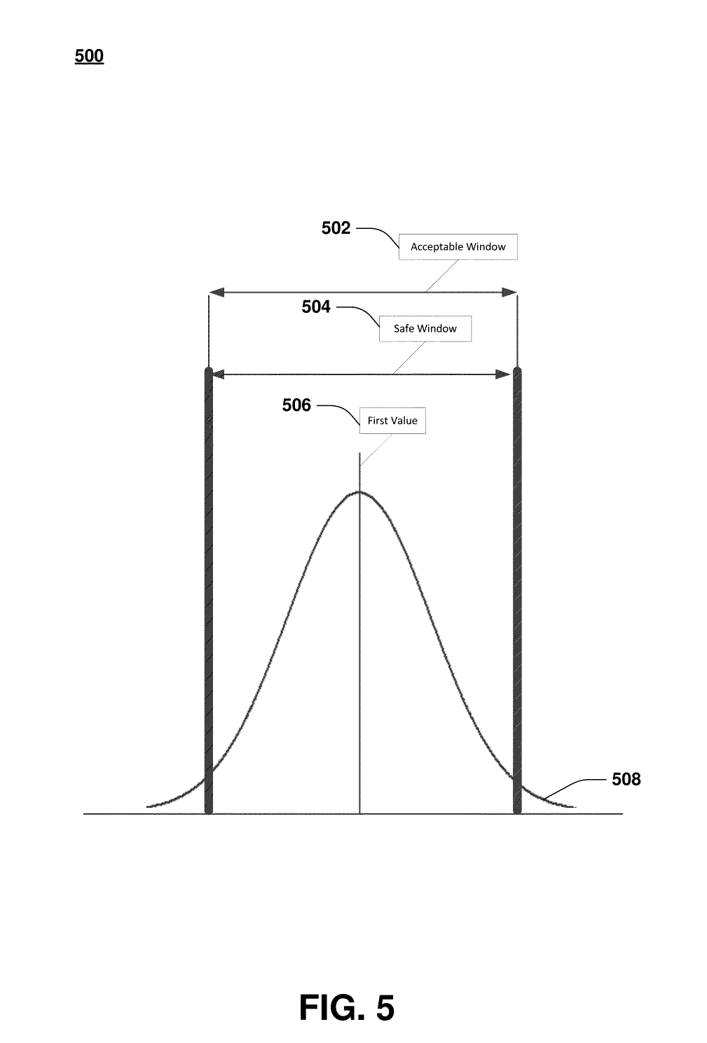

FIG. 5 illustrates an example of graphical representation 500. A first value 506 may represent information and/or content indicative of at least one component corresponding to and/or descriptive of a user. For example, the first value 506 may be a numerical value which quantifies the component (e.g., a numerical value associated with the user's sociability, a numerical value associated with the user's intelligence, a numerical value associated with the user's compassion, etc.). A distribution 508 may represent a relationship of the at least one component for one or more users (e.g., a population of users). For example, the distribution 508 may be a normal distribution, a bimodal distribution, a skewed distribution, a binomial distribution, a geometric distribution, a Poisson distribution, an exponential distribution, a gamma distribution, a beta distribution, a Bernoulli distribution, a chi-squared distribution and/or one or more other types of distributions. A window of compatibility may comprise, for example, a safe window 504 and/or an acceptable window 502. The safe window 504 may represent the importance and/or priority of the at least one component for the user (e.g., a first person's compassion) that indicates a preferred level of compatibility. For example, the safe window 504 may represent the user's indication that a particular (e.g., higher, lower, etc.) level and/or range of compassion is preferred (e.g., ideal). In some instances, the safe window 504 may be represented by at least a portion (e.g., some but not all, or all) of a standard score (e.g., a z-score) and/or a plurality of standard scores (e.g., a plurality of z-scores). The acceptable window 502 may represent the importance and/or priority of the at least one component for the user (e.g., a first person's compassion) that indicates an adequate (e.g., acceptable and/or “good enough”, but not necessarily ideal) level and/or range of compatibility. For example, the acceptable window 502 may represent the user's indication that a particular (e.g., higher, lower, etc.) level and/or range of compassion is adequate. In some instances, the acceptable window 502 may be represented by at least a portion of a standard score (e.g., a z-score) and/or a plurality of standard scores (e.g., a plurality of z-scores). The graphical representation 500 may comprise, for example, the safe window 504 representing a preferred level of compatibility which may be two (e.g., or more, or less) standard scores (e.g., two z-scores) and the acceptable window 502 representing an adequate level of compatibility which may (e.g., also) be two (e.g., or more, or less) standard scores (e.g., two z-scores). The safe window 504 may, for example, represent a decreased importance and/or priority of the at least one component for the user (e.g., the first person's compassion) that indicates a decreased preferred level of compatibility relative to the safe window 304 illustrated in FIG. 3.

A match between a first user and a second user may represent a similarity and/or overlap between at least the first user and the second user. For example, a first window of compatibility associated with the first user corresponding to a least one component (e.g., a first person's indication of the importance of sociability) may have at least some similarity and/or overlap with a second window of compatibility associated with the second user corresponding to the at a least one component (e.g., a second person's indication of the importance of sociability).

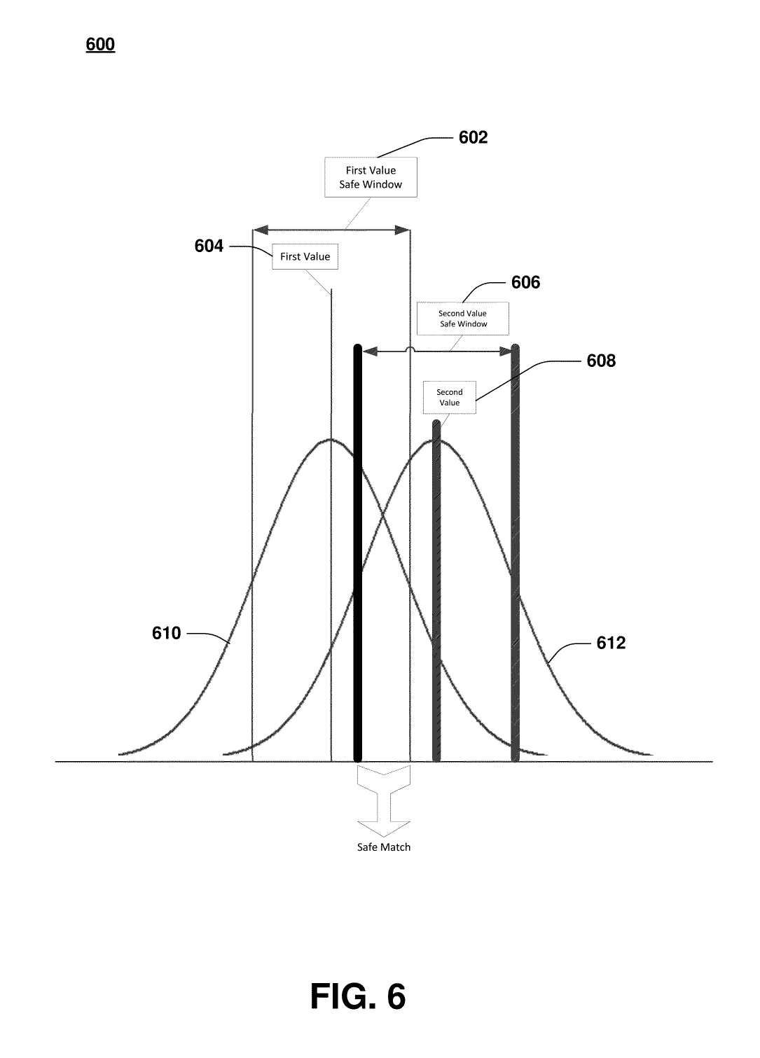

FIG. 6 illustrates an example of a graphical representation 600. A first value 604 may represent information and/or content indicative of at least one component corresponding to and/or descriptive of a first user. For example, the first value 604 may be a numerical value which quantifies the component (e.g., a numerical value associated with the first user's sociability, a numerical value associated with the first user's intelligence, a numerical value associated with the first user's compassion, etc.). A second value 608 may represent information and/or content indicative of the at least one component corresponding to and/or descriptive of a second user. For example, the second value 608 may be a numerical value which quantifies the component (e.g., a numerical value associated with the second user's sociability, a numerical value associated with the second user's intelligence, a numerical value associated with the second user's compassion, etc.). A first distribution 610 may represent a relationship of the at least one component (e.g., for one or more users (e.g., a population of users)). A second distribution 612 may represent a relationship of the at least one component (e.g., for one or more users (e.g., a population of users)). For example, the first distribution 610 and/or the second distribution 612 may be a normal distribution, a bimodal distribution, a skewed distribution, a binomial distribution, a geometric distribution, a Poisson distribution, an exponential distribution, a gamma distribution, a beta distribution, a Bernoulli distribution, a chi-squared distribution and/or one or more other types of distributions. A first safe window 602 may represent the importance and/or priority of the at least one component for the first user (e.g., a first person's compassion) that indicates a preferred level of compatibility. For example, the first safe window 602 may represent the first user's indication that a particular (e.g., higher, lower, etc.) level and/or range of compassion is preferred (e.g., ideal). In some instances, the first safe window 602 may be represented by at least a portion (e.g., some but not all, or all) of a standard score (e.g., a z-score) and/or a plurality of standard scores (e.g., a plurality of z-scores). A second safe window 606 may represent the importance and/or priority of the at least one component for the second user (e.g., a second person's compassion) that indicates a preferred level of compatibility. For example, the second safe window 606 may represent the second user's indication that particular (e.g., a higher, lower, etc.) level and/or range of compassion is preferred (e.g., ideal). In some instances, the second safe window 606 may be represented by at least a portion (e.g., some but not all, or all) of a standard score (e.g., a z-score) and/or a plurality of standard scores (e.g., a plurality of z-scores). A safe match between the first user and the second user may represent a (e.g., value of) similarity and/or overlap between at least the first safe window 602 and the second safe window 606 and/or a similarity and/or overlap between the first distribution 610 and the second distribution 612. For example, the area which is represented by the overlap between the first distribution 610 and the second distribution 612 which further falls within the overlap between the first safe window 602 and the second safe window 606 may represent the safe match. In some instances, the safe match may represent a probability.

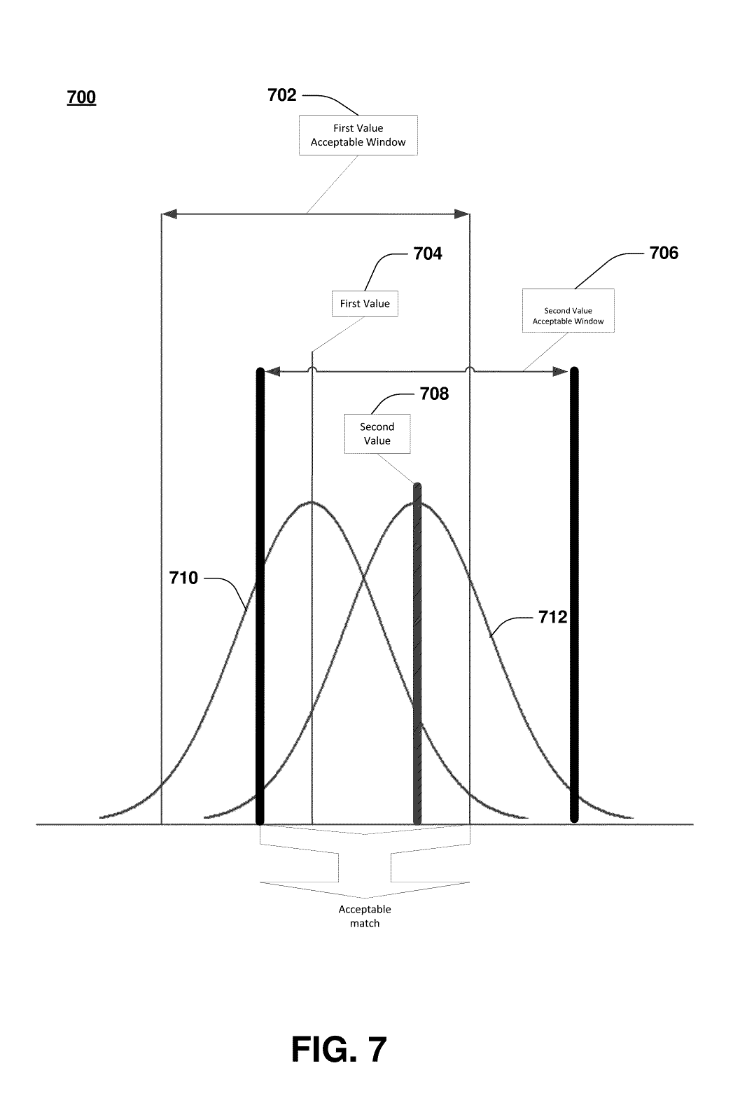

FIG. 7 illustrates an example of a graphical representation 700. A first value 704 may represent information and/or content indicative of at least one component corresponding to and/or descriptive of a first user. For example, the first value 704 may be a numerical value which quantifies the component (e.g., a numerical value associated with the first user's sociability, a numerical value associated with the first user's intelligence, a numerical value associated with the first user's compassion, etc.). A second value 708 may represent information and/or content indicative of the at least one component corresponding to and/or descriptive of a second user. For example, the second value 708 may be a numerical value which quantifies the component (e.g., a numerical value associated with the second user's sociability, a numerical value associated with the second user's intelligence, a numerical value associated with the second user's compassion, etc.). A first distribution 710 may represent a relationship of the at least one component (e.g., for one or more users (e.g., a population of users). A second distribution 712 may represent a relationship of the at least one component (e.g., for one or more users (e.g., a population of users)). For example, the first distribution 710 and/or the second distribution 712 may be a normal distribution, a bimodal distribution, a skewed distribution, a binomial distribution, a geometric distribution, a Poisson distribution, an exponential distribution, a gama distribution, a beta distribution, a Bernoulli distribution, a chi-squared distribution and/or one or more other types of distributions. A first acceptable window 702 may represent the importance and/or priority of the at least one component for the first user (e.g., a first person's compassion) that indicates an adequate (e.g., acceptable and/or “good enough”, but not necessarily ideal) level and/or range of compatibility. For example, the first acceptable window 702 may represent the first user's indication that a particular (e.g., higher, lower, etc.) level and/or range of compassion is adequate. In some instances, the first acceptable window 702 may be represented by at least a portion of a standard score (e.g., a z-score) and/or a plurality of standard scores (e.g., a plurality of z-scores). A second acceptable window 706 may represent the importance and/or priority of the at least one component for the second user (e.g., a second person's compassion) that indicates an adequate (e.g., acceptable and/or “good enough”, but not necessarily ideal) level and/or range of compatibility. For example, the second acceptable window 706 may represent the second user's indication that a particular (e.g., higher, lower, etc.) level and/or range of compassion is preferred. In some instances, the second acceptable window 706 may be represented by at least a portion of a standard score (e.g., a z-score) and/or a plurality of standard scores (e.g., a plurality of z-scores). An acceptable match between the first user and the second user may represent a (e.g., value of) similarity and/or overlap between at least the first acceptable window 702 and the second acceptable window 706 and/or a similarity and/or overlap between the first distribution 710 and the second distribution 712. For example, the area which is represented by the overlap between the first distribution 710 and the second distribution 712 which further falls within the overlap between the first acceptable window 702 and the second acceptable window 706 may represent the acceptable match. In some instances, the acceptable match may represent a probability.

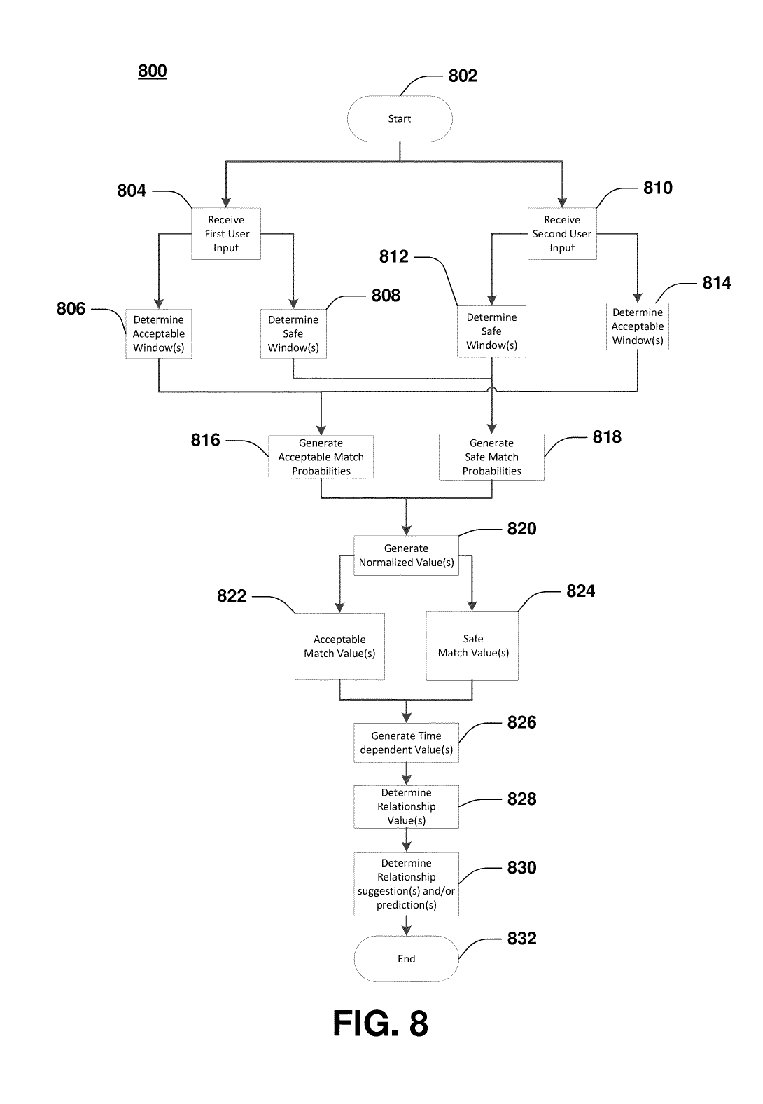

One embodiment of a method 800 of generating a relationship prediction and/or a relationship suggestion is illustrated in FIG. 8. At 802, the method 800 starts. At 804, a first user input may be received. In one example, the first user input may correspond to and/or be received from a first user (e.g., a first person). The first user input, for example, may comprise data corresponding to and/or representative of the first user. At 806, at least one acceptable window may be generated for the first user based upon the first user input. In some instances, the at least one acceptable window may be represented by a standard score (e.g., a z-score) which indicates an adequate (e.g., acceptable and/or “good enough”, but not necessarily ideal) level and/or range of compatibility. For example, the first user may indicate that a particular (e.g., higher, lower, etc.) level and/or range of sociability is adequate and a standard score (e.g., a z-score) of two is assigned. At 808, at least one safe window may be generated for the first user based upon the first user input. In some instances, the at least one safe window may be represented by a standard score (e.g., a z-score) which indicates a preferred level of compatibility. For example, the first user may indicate that a particular (e.g., higher, lower, etc.) level and/or range of sociability is preferred (e.g., ideal) and a standard score (e.g., a z-score) of one is assigned. At 810, a second user input may be received. In one example, the second user input 810 may correspond to and/or be received from the first user, a second user, a first simulated user, a second simulated user, a population of users, and/or a portion of population of users. The second user input, for example, may comprise data corresponding to and/or representative of the second user, the first simulated user, the second simulated user, the population of users, and/or the portion of the population of users. At 812, at least one acceptable window may be generated for the second user based upon the second user input. In some instances, the at least one acceptable window may be represented by a standard score (e.g., a z-score) which indicates an adequate (e.g., acceptable and/or “good enough”, but not necessarily ideal) level and/or range of compatibility. For example, the second user may indicate that a particular (e.g., higher, lower, etc.) level and/or range of sociability is adequate and a standard score (e.g., a z-score) of two is assigned. At 814, at least one safe window may be generated for the second user based upon the second user input. In some instances, the at least one safe window may be represented by a standard score (e.g., a z-score) which indicates a preferred level of compatibility. For example, the second user may indicate that a particular (e.g., higher, lower, etc.) level and/or range of sociability is preferred (e.g., ideal) and a standard score (e.g., a z-score) of one is assigned.

At 816, an acceptable match (e.g., between the first user and the second user) may be generated. The acceptable match may represent a (e.g., value of) similarity and/or overlap between at least the first acceptable window corresponding to the first user input and at least the second acceptable window corresponding to the second user input, and/or one or similarities and/or overlaps between one or more other acceptable windows corresponding to the first user input and one or more other acceptable windows corresponding to the second user input. For example, the acceptable match may correspond to a similarity and/or overlap between the first user's indication of an adequate level of compatibility with regards to a component (e.g., sociability) and the second user's indication of an adequate level of compatibility with regards to the component (e.g., sociability). The acceptable match may represent an acceptable match probability. At 818, a safe match (e.g., between the first user and the second user) is generated. The safe match may represent a (e.g., value of) similarity and/or overlap between at least the first safe window corresponding to the first user input and at least the second safe window corresponding to the second user input, and/or one or similarities and/or overlaps between one or more other safe windows corresponding to the first user input and one or more other safe windows corresponding to the second user input. For example, the safe match may correspond to a similarity and/or overlap between the first user's indication of a preferred level of compatibility with regards to the component (e.g., sociability) and the second user's indication of a preferred level of compatibility with regards to the component (e.g., sociability). The safe match may represent a safe match probability.

A function may provide for a relationship between one or more inputs and one or more outputs. For example, at least one user input may be applied to the function to generate at least one relationship suggestion and/or prediction. In some instances, the function may comprise a partition function, a logistic function, a numerical derivative function, a polynomial function, an exponential function, a normalization function and/or an algorithm.

At 820, one or more match probabilities generated at 816 and/or 818 may be processed to generate at least one normalized value. For example, the at least one normalized value may be generated based upon the acceptable match and/or the safe match via a normalization function. The normalization function may, for example, comprise one or more factors that determine the at least one normalized value. For example, a normalization factor may be a percentage, a real value, or an arbitrary value.

At 822, at least one value associated with the acceptable match may be generated. An acceptable match value, for example, may comprise a numerical value associated with an adequate level of compatibility between the first user and the second user and/or between the first user input and the second user input. At 824, at least one value associated with the safe match may be generated. A safe match value, for example, may comprise a numerical value associated with a preferred level of compatibility between the first user and the second user and/or between the first user input and the second user input.

At 826, at least one time dependent value is generated. A time dependent value may comprise at least one numerical value dependent on a time which may represent a relationship between the first user and the second user and/or between the first user input and the second user input. A time dependent value may alternatively and/or additionally comprise a first numerical value dependent on time which may represent a relationship between the first user and the second user and/or between the first user input and the second user input combined with a second numerical value dependent on time which may represent a second (e.g., same or different) relationship between the first user and the second user and/or between the first user input and the second user input (e.g., a cumulative value). For example, at least one numerical value dependent on time may represent a probability of a safe match and/or an acceptable match between the first user and the second user and/or between the first user input and the second user input. In some instances, a time dependent value may correspond to a function (e.g., a partition function, a logistic function, a numerical derivative function, a polynomial function, an exponential function, a normalization function and/or an algorithm). For example, one or more time dependent values corresponding to the function (e.g., partition function) may be determined as an output of a summation of at least one component of a user (e.g., a user's sociability) combined with (e.g., multiplied by) a natural exponent raised to a product of a value corresponding to a level of compatibility (e.g., a preferred level of compatibility corresponding to safe window and/or an adequate level of compatibility corresponding to an acceptable window) and (e.g., a model of) time.

A function may be associated with at least one factor (e.g., rigidity, depreciation, candidate factor, people met per time period, and/or turning point) which determines the time dependent value. For example, rigidity may indicate an exponential decay to at least one time dependent value. A function which may be associated with a factor such as depreciation (e.g., a value associated with an undesirable level of compatibility) may represent a decrease in the probability of a safe match and/or an acceptable match between a first user (e.g., a first person) and a second user (e.g., a second person). It may be appreciated that the function may be determined based upon the first user input (e.g., a first person indicating an undesirable level of compatibility) and/or the second user input (e.g., a second user, a simulated user, a population of users, and/or a portion of the population of users indicating an undesirable level of compatibility). The function may be associated with a factor such as candidate factor (e.g., a value associated with a manual adjustment to a level of compatibility) and may represent an increase and/or decrease in the probability of a safe match and/or an acceptable match between the first user (e.g., a first person) and the second user (e.g., a second person). The function may be associated with a factor such as people met per time period (e.g., a value associated with a number of people met over an (e.g., arbitrary, defined, etc.) time period) may represent an increase and/or decrease in the probability of a safe match and/or an acceptable match between the first user and the second user. For example, an increase in the factor of people met per time period may lead to an increase in the probability of a safe match and/or an acceptable match between the first user and the second user and a decrease in the factor of people met per time period may lead to a decrease in the probability of a safe match and/or an acceptable match between the first user and the second user. The function may be associated with a factor such as turning point (e.g., a value associated with a time at which a significant change may occur) and may represent an increase and/or decrease at an arbitrary time of the probability of a safe match and/or an acceptable match between the first user and the second user.

At 828, at least one relationship value is determined. The relationship value may correspond to a cumulative probability dependent on time. For example, the relationship value may represent the probability of a safe match at the time of one year (e.g., in the future). At 830, at least one relationship suggestion and/or at least one relationship prediction may be determined. For example, a relationship suggestion may suggest that a first person should disengage from a (e.g., romantic) relationship with a second person. In another example, a relationship prediction may predict a time at which a first person may (e.g., be encouraged to) engage in a relationship with a second person (e.g., with whom the first person has not yet engaged in a relationship). At 832, the method ends.

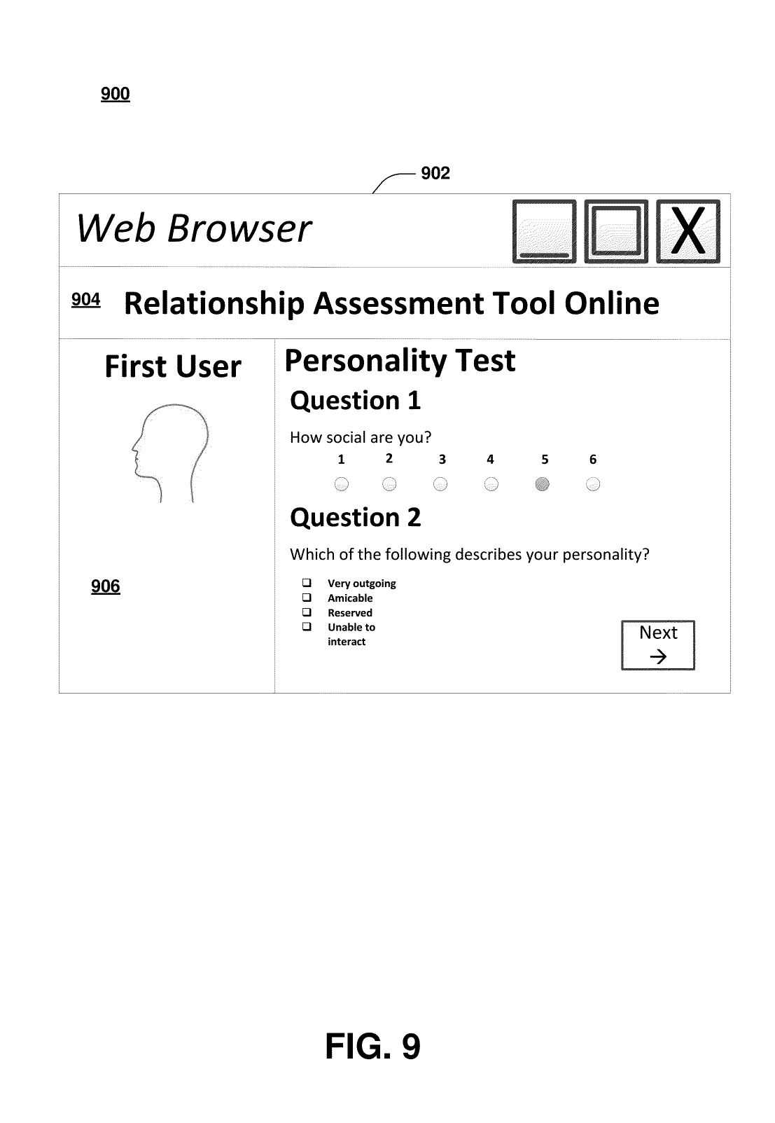

FIG. 9 illustrates an example 900 of a user interface, such as a website. The website may be accessed via a web browser 902 and may be used to receive user input (e.g., a first user input from and/or corresponding to a first user). The website may comprise a first area 904, which may comprise text and/or an image (e.g., indicating the title of the website), as well as second area 906 which may comprise information and/or content in the form of text and/or an image representative of a user (e.g., the first user). The website may comprise a third area 908 which may comprise text and/an image used to receive user input representative of information and/or content corresponding to and/or indicative of the user's personality (e.g., a personality test) and/or one or more components associated with the user. For example, the user input received in area 908 may be used to determine one or more (e.g., relationship) values. It may be appreciated that one or more other user interfaces may be used instead of the website.

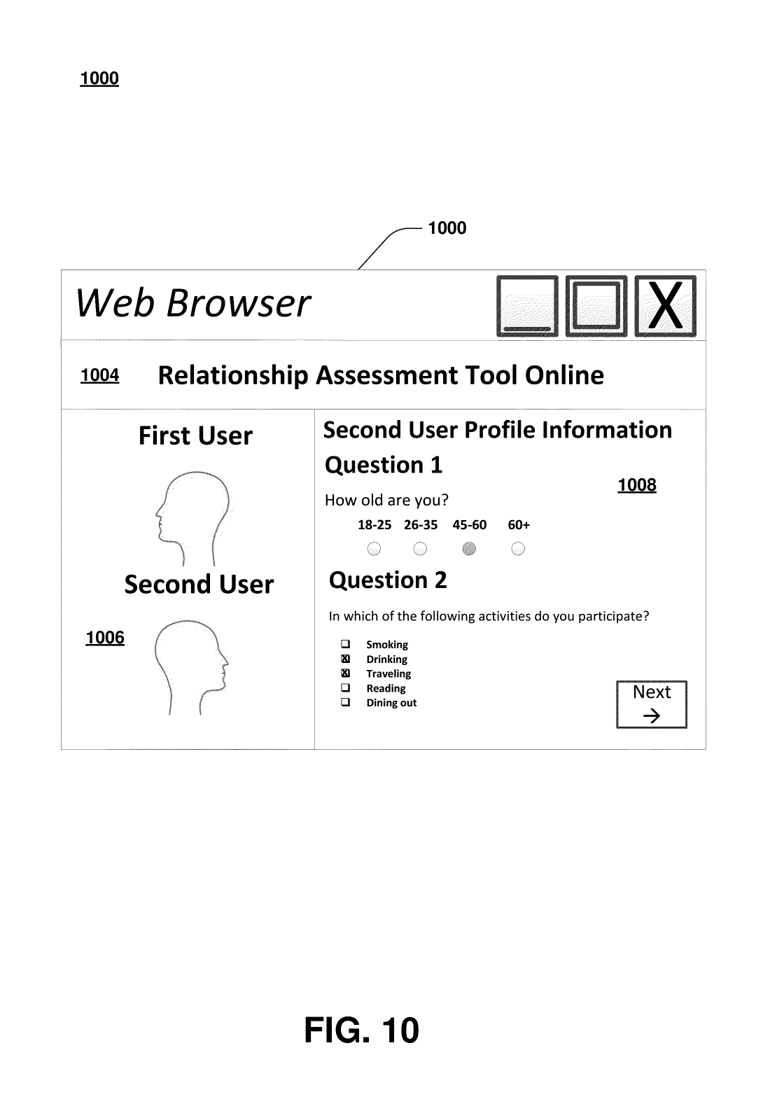

FIG. 10 illustrates an example 1000 of a user interface, such as website. The website may be accessed via a web browser 1002 and may be used to receive user input (e.g., a first user input from and/or corresponding to a first user and/or a second user input from and/or corresponding to the first user and/or the second user). The website may comprise a first area 1004, which may comprise text and/or an image (e.g., indicating the title of the website), as well as second area 1006 which may comprise information and/or content in the form of text and/or an image representative of the first user (e.g., the first person) and the second user (e.g., the second person). The website may comprise a third area 1008 which may comprise text and/an image used to receive second user input representative of information and/or content of the second user (e.g., profile information representative of the second user) which may or may not be received from the first user and/or the second user. For example, the user input received in area 1008 may be used as second user input. In some instances, the FIG. 10 illustrates an example of the second user input (e.g., corresponding to the second user) determined and/or provided by the first person. It may be appreciated that one or more other user interfaces may be used instead of the website.

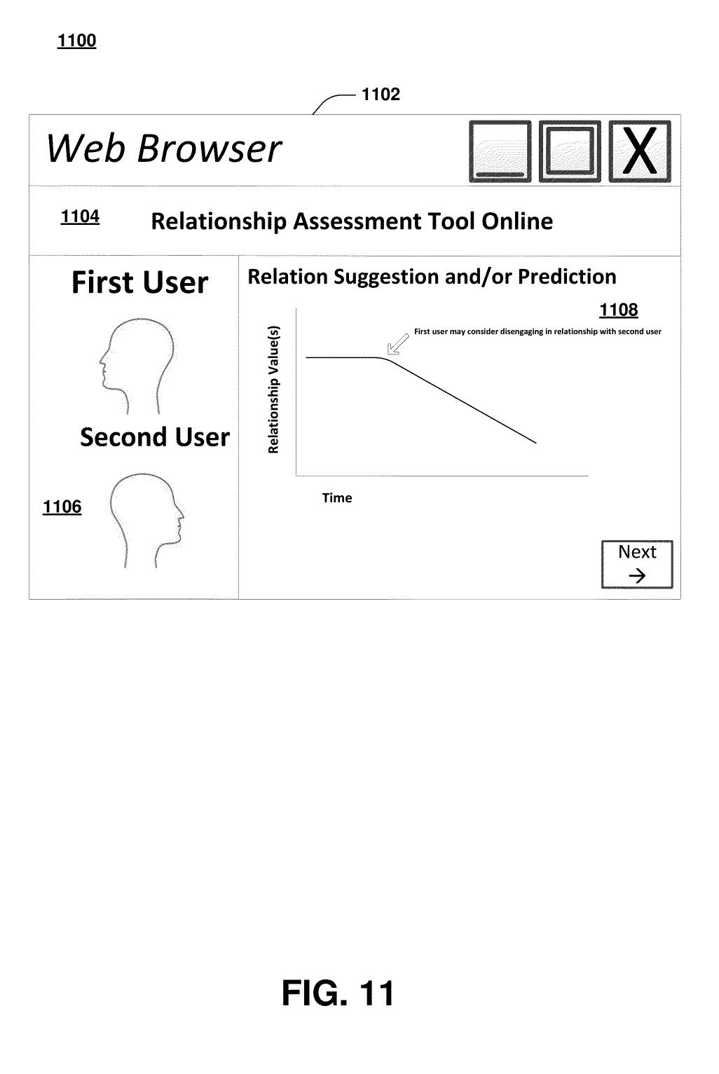

FIG. 11 illustrates an example 1100 of a user interface, such as a website. The website may be accessed via a web browser 1102 and may be used to receive user input (e.g., a first user input from a first person and a second user input from the first user). The website may comprise a first area 1104, which may comprise text and/or an image (e.g., indicating the title of the website), as well as second area 1106 which may comprise information and/or content in the form of text and/or an image representative of the first user (e.g., the first person) and the second user (e.g., the second person). The website may comprise a third area 1108 which may comprise text and/an image used to provide a relationship suggestion and/or prediction for the first user and/or the second user. For example, the information and/or content provided in area 1108 may be predict a time (e.g., in the future) when the first user (e.g., a first person) may consider disengaging from a relationship with the second user (e.g., a second person). It may be appreciated that one or more other user interfaces may be used instead of the website.

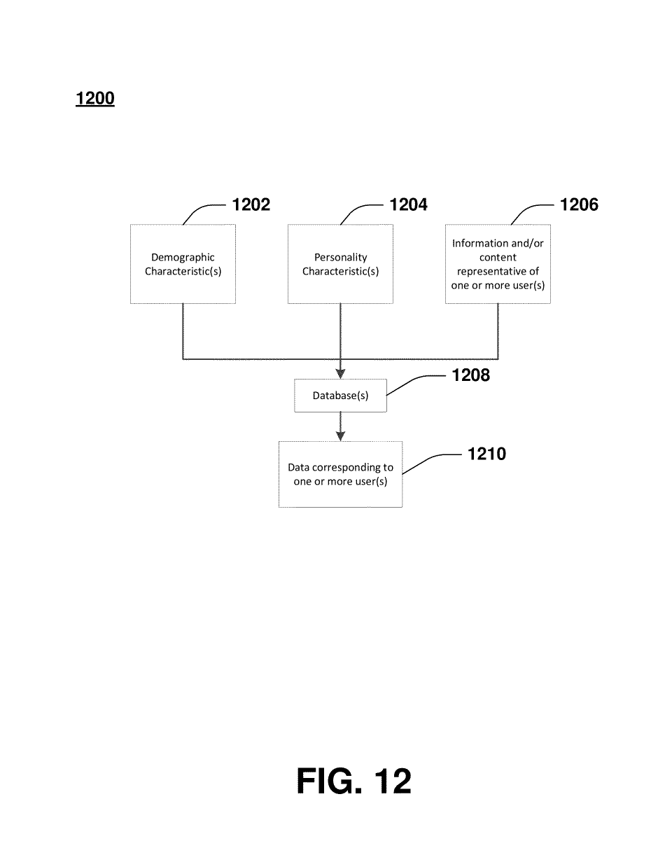

FIG. 12 illustrates a system 1200 for determining data corresponding to one or more users 1210. In some instances, data corresponding to one or more users 1210 may be used for user input. For example, data corresponding to one or more users 1210 may represent a second user and/or a population of users. The data corresponding to one or more users 1210 may be based upon at least one database 1208. The database 1208 may be generated based upon input received from a website, a survey, a census, social media, internet search history, internet purchase history and/or one or more other sources. The database 1208 may comprise one or more demographic characteristics 1202, one or more personality characteristics 1204, and/or information and/or content representative of one or more users 1206. One or more demographic characteristics 1202, for example, may comprise a political view, a religion, an age, a gender, a race, a location, a career field, a level of education, a language, a culture, a financial status, a disability, a habit and/or one or more other demographic characteristics. One or more personality characteristics 1204, for example, may comprise an emotional temperament, a social style, a cognitive mode, physicality, a relationship skill, an ethic, a belief, a key experience and/or one or more other personality characteristics. Information and/or content representative of one or more users 1206 may comprise one or more other characteristics (e.g., similar to and/or different than demographic characteristics, personality characteristics, etc.).

Algorithms may exist wherein users are not specifically people or user groups are similar and/or identical in nature across groups. A group of users may consist of simulations, real or potential options, and/or individuals. In the description, the relationship may be romantic but it must be appreciated the process is not limited to romantic options. Relationships are relationships between a user and options, which are a combination of various parameters, such as physical, psychological, behavioral, or financial quantities.

It may be appreciated that one or more of the techniques described herein may be used to perform decision and/or option analysis and/or determine values that may or may not be associated with relationships. For example, values associated with educational (e.g., college) and career plans may be determined, and may be a function of user desire, economic outcomes, etc. In another example, values associated with (e.g., new and/or used) cars may be determined, and may be a function of user desire, potential recurring costs, etc. In another example, values associated with real estate may be determined, and may be a function of user desire, availability, market trending, etc. In another example, values associated with employment may be determined, and may be a function of employer desire, employee personality, employer culture, employee background, etc. In another example, values associated with sales strategy and focus may be determined, and may be a function of sales goals, in-house sales history, in-market trending, etc.

In some embodiments, desire data may be received from one or more users. The desire data may correspond to one or more traits desired by the one or more users. The traits may be interpreted as a range and/or “window” of one or more acceptable traits. A search, of a database, for example, may be performed (e.g., using some numerical method for matchmaking (single value decomposition, distance formula, etc.)). For example, an algorithm matching with demographics (e.g., geographic, job, race, etc.) may be performed across d-dimensions, which may, for example, result in ranking. A (e.g., flattened and/or ranked) list may be created, based upon the search, as a function of demographic data which may be N-dimension (e.g., race, geography, careers, colleges, etc.). Matching data across as many demographic dimensions relevant to the user may be ranked. This data must then be dynamically displayed in a relevant manner to the user. For example, a map illustrating populations and/or demographics corresponding to one or more locations may be displayed. In some embodiments, the displayed data may be topographic maps, color maps, heat maps, data clouds, 3D webs, flattened for greater than 3D displays, tables, charts, flatted 3D images, scores, thermometers, meters and/or sliding scales.

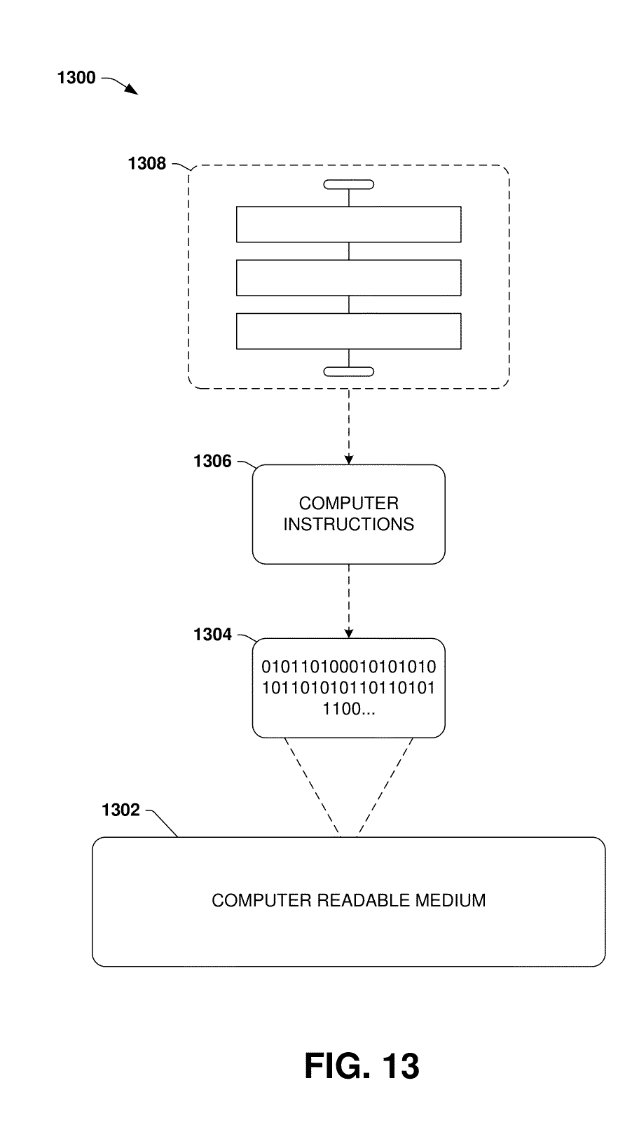

Still another embodiment involves a computer-readable medium comprising processor-executable instructions configured to implement one or more of the techniques presented herein. An exemplary computer-readable medium that may be devised in these ways is illustrated in FIG. 13, wherein the implementation 1300 comprises a computer-readable medium 1302 (e.g., a CD-R, DVD-R, or a platter of a hard disk drive), on which is encoded computer-readable data 1304. This computer-readable data 1304 in turn comprises a set of computer instructions 1306 configured to operate according to one or more of the principles set forth herein. In one such embodiment 1300, the processor-executable computer instructions 1306 may be configured to perform a method, such as at least some of the exemplary method 100 of FIG. 1, for example. In another such embodiment, the processor-executable instructions 1306 may be configured to implement a system, such as at least some of the exemplary system 200 of FIG. 2 and/or at least some of the exemplary system 1200 of FIG. 12, for example. Many such computer-readable media 1302 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

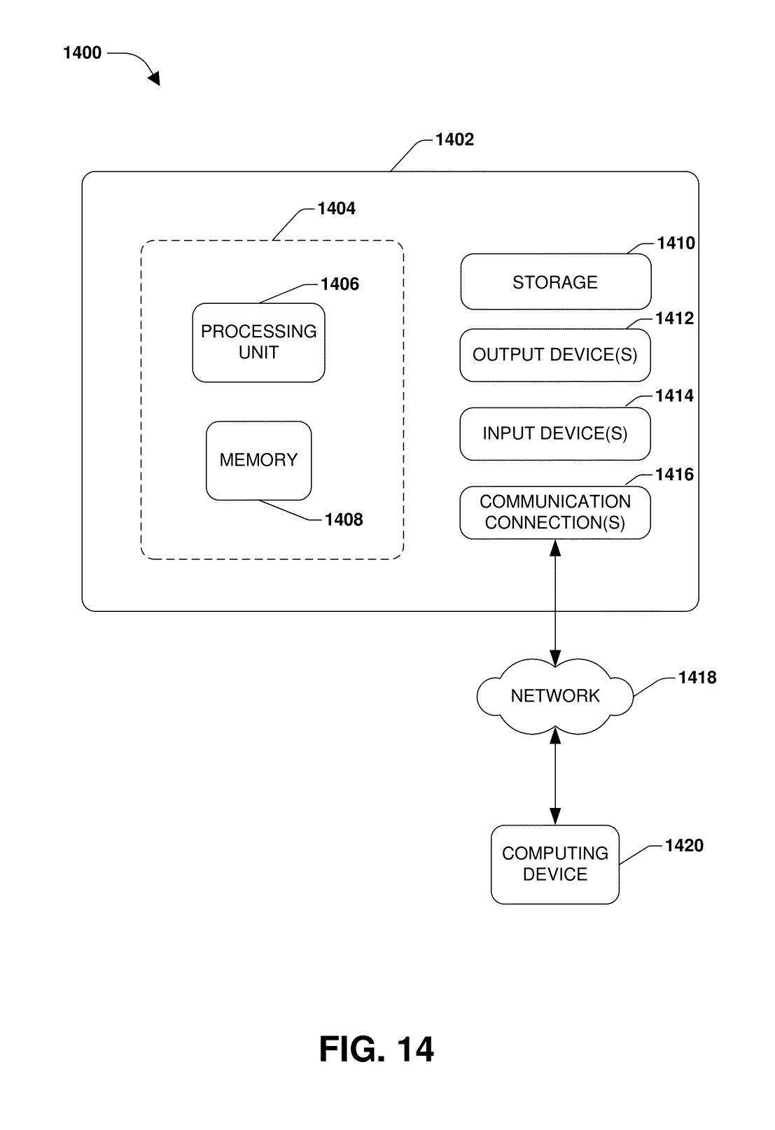

FIG. 14 and the following discussion provide a brief, general description of a suitable computing environment to implement embodiments of one or more of the provisions set forth herein. The operating environment of FIG. 14 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 14 illustrates an example of a system 1400 comprising a computing device 1402 configured to implement one or more embodiments provided herein. In one configuration, computing device 1402 includes at least one processing unit 1406 and memory 1408. Depending on the exact configuration and type of computing device, memory 1408 may be volatile (such as RAM, for example), non-volatile (such as ROM, flash memory, etc., for example), or some combination of the two. This configuration is illustrated in FIG. 14 by dashed line 1404.

In other embodiments, device 1402 may include additional features and/or functionality. For example, device 1402 may also include additional storage (e.g., removable and/or non-removable) including, but not limited to, magnetic storage, optical storage, and the like. Such additional storage is illustrated in FIG. 14 by storage 1410. In one embodiment, computer readable instructions to implement one or more embodiments provided herein may be in storage 1410. Storage 1410 may also store other computer readable instructions to implement an operating system, an application program, and the like. Computer readable instructions may be loaded in memory 1408 for execution by processing unit 1406, for example.

The term “computer readable media” as used herein includes computer storage media. Computer storage media includes volatile and nonvolatile, removable and non-removable media implemented in any method or technology for storage of information such as computer readable instructions or other data. Memory 1408 and storage 1410 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1402. Any such computer storage media may be part of device 1402.

Device 1402 may also include communication connection(s) 1416 that allows device 1402 to communicate with other devices. Communication connection(s) 1416 may include, but is not limited to, a modem, a Network Interface Card (NIC), an integrated network interface, a radio frequency transmitter/receiver, an infrared port, a USB connection, or other interfaces for connecting computing device 1402 to other computing devices. Communication connection(s) 1416 may include a wired connection or a wireless connection. Communication connection(s) 1416 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1402 may include input device(s) 1414 such as keyboard, mouse, pen, voice input device, touch input device, infrared cameras, video input devices, and/or any other input device. Output device(s) 1412 such as one or more displays, speakers, printers, and/or any other output device may also be included in device 1402. Input device(s) 1414 and output device(s) 1412 may be connected to device 1402 via a wired connection, wireless connection, or any combination thereof. In one embodiment, an input device or an output device from another computing device may be used as input device(s) 1414 or output device(s) 1412 for computing device 1402.

Components of computing device 1402 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1402 may be interconnected by a network. For example, memory 1408 may be comprised of multiple physical memory units located in different physical locations interconnected by a network.

Those skilled in the art will realize that storage devices utilized to store computer readable instructions may be distributed across a network. For example, a computing device 1420 accessible via a network 1418 may store computer readable instructions to implement one or more embodiments provided herein. Computing device 1402 may access computing device 1420 and download a part or all of the computer readable instructions for execution. Alternatively, computing device 1402 may download pieces of the computer readable instructions, as needed, or some instructions may be executed at computing device 1402 and some at computing device 1420.

### Further Discussion

Considerable effort has gone into in the development of personality tests that match people together based on results of psychometric assessment. While proprietary, there may be rudimentary methods available to perform matchmaking. However, existing services for matchmaking may merely consider single users and identify potential matches between people who have not yet even met.

While this may serve as a viable means of introducing people who may be compatible, it may neither offer the ability to determine long-term quality of relationship as a function of assessed personality and other system behavior nor the ability to weight a romantic option against other options. Inherent in the latter may be the ability to simply forecast the probability of meeting a person, whether online or offline, who may be considered a compatible romantic match.

Work may have been done to refine aspects of the secretary problem in a manner that provides additional clarity to its application in non-idealized contexts. For instance, this may include selecting subpopulations of a population, human performance in solving the secretary problem, discounting, weighting, and many others. The user may be the subject, the individual making the romantic decision. Groups contain individuals that may or may not meet high-level demographic requirements set by the user. High-level demographic requirements include gender, age, etc. Subgroups exist and can be most simply understood as a subset of a whole group, or more precisely, the intersection of two or more groups. Traits may be quantitatively assessed values of personality of individuals. Suitors may be individuals within a group that meet the user's high-level demographic criteria. There may be two categories of suitors. Failed matches may be suitors that the user will not entertain for a relationship due to mismatch of personality traits, lack of attraction, etc. or suitors that will not accept the user for similar reasons. Matches may be suitors who fit the user's requirements and vice versa. In cases where the user may be in a relationship, a partner may be the individual with whom the user shares a relationship. Quality may be the user-based criterion by which we determine utility along any trait dimension. Though overly simplified, we can consider D-dimensional proximity of a suitor's traits from the user's ideal partner traits an example of quality. Though for psychological and relationship dynamics (not psychodynamic!) this may be an oversimplification.

With key system elements defined, we make the following assumptions that vary from existing solutions of the secretary problem: A romantic partner may already exist which has its own unique value to the user. User behavior, such as character and social behavior, may be unknown a priori. There may exist more than one group that the user interacts with. These groups may be distinct and unique except in cases of an intersection of group that the user interacts with, creating a subgroup. Information exists or can be meaningfully extrapolated from other information on the amount of suitors, failed matches, and matches within a group. Information exists or can be meaningfully extrapolated from other information on the frequency of interaction between a user and groups with whom the user interacts. Information exists or can be meaningfully extrapolated for bias of interaction of subgroups within known groups. Information regarding user preferences and romantic history may be known from which reasonable extrapolations on romantic attraction and success can be made. Values representing quality, user satisfaction, and/or stability of a relationship exist and can be determined using utility functions which may be themselves a function of constants, initial conditions, personality traits, etc.

With these assumptions we see a contrast with previous variations of the secretary problem. Notably, unknown user behavior and social context, incorporation of a value function for each suitor and match, dynamic system behavior, and the existence of significant quantified information of groups present a new variation of the secretary problem. The available, closed-form solutions in literature may not be relevant, appropriate and/or descriptive.

In acknowledgement of the open-endedness of the problem as allowed by our assumptions, we have developed a numerical framework for simulating the availability and value of romantic options. The Example Embodiment algorithm seeks to simplify a complex, highly dimensional problem in a manner that provides consistent results robust to varying user context. We further acknowledge that there may be a limited ability to genuinely quantify initial conditions of social behavior, let alone personality, love, and emotions. The evolution of love and romantic options may be truly chaotic—but Example Embodiment provides a sensible estimate.

Our algorithm for forecasting long-term romantic futures must be interdisciplinary; i.e. a framework that strictly utilizes mathematical and economic description without incorporating sociological and psychometric elements cannot provide any meaningful insights, let alone solutions. In our theoretical work, we determined many shared variables between psychometric results and factors used in sociological modeling and derived utility functions.

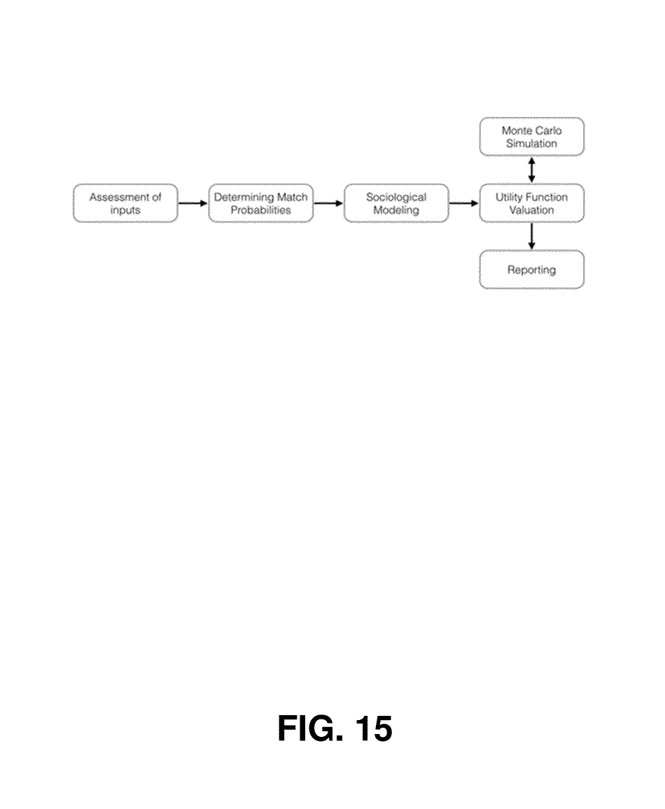

FIG. 15 (e.g., high level process) depicts the flow of the algorithm, not the user experience. We assume datasets or extrapolations exist or that allow for meaningful calculation of required secondary variables, e.g. match probabilities.

Assessment of inputs may be the acquisition of user data such that all primary variables, e.g. psychometric test results, may be obtained. In determining match probabilities we utilize existing databases or extrapolations thereof to determine raw probabilities, PG(t), of finding matches of various quality across G groups that the user interacts with. Sociological modeling forecasts rates of interaction between a user and groups with which they interact based on which cumulative probabilities of finding a match can be ascertained. Utility function valuation calculates the utility as a function of time for the user for any given relationship and the utility of strictly being alone. To simulate potential future matches we generate a quasi-random set of suitors via Monte Carlo simulation. All results can be later reported. The following subsections further detail these processes.

Assessment of Inputs

Some and/or all required inputs may be entered by the user. These inputs cover user psychometric assessment that assesses user personality and desired traits in a partner, populations to which the user belongs, their history in these groups, and emotions about the user's current relationship, if applicable.

Determining Match Probabilities

From user inputs, we can determine the subgroups that a user interacts with from which suitors exist. User desired partner traits may be determined in terms of a window of compatibility for each desired trait, i.e. a range of trait values consistent with the user personality self-assessment. From subgroups and windows of compatibility we can derive the single encounter probability of finding a match. Single encounter probability may be the chance that on any given encounter, the person in a (sub)group may be a romantic match for the user. It may be found by searching within the database for all users within desired subgroups by the user across all trait dimensions. All matches falling within all windows of compatibility can also be further constrained based on proximity with the mean of the windows. This proximity can be considered a possible measure of match quality with more distant matches being of less quality.

In the event a subgroup may not be statistically significant its definitions will be varied in a self-similar manner as a function of the most sensible local topographies in the dataset.

Probabilities may be also determined in time based on direct user input and personality self-assessment to adjust for varying interest in partners in time. For instance, we consider the effect of increasing or decreasing sizes of windows of compatibility in time to account for romantic desperation or neuroticism in time. Forecasted demographic shifts in time at static locations or demographics patterns can also be incorporated. This will vary the single encounter probability of finding a match in time.

Sociological Modeling

Without knowing the number of people a user interacts the single encounter probability of finding a match may be of no consequence. Therefore it may be desired to estimate the number of people a user interacts with within each (sub)group to determine the probability of finding a partner.

We maintain such an estimate of frequency of interaction may be calculable and, minimally, a function of user personality, population characteristics such as demographics and size, and user social history within the group. Such estimates may be approximate and approximately verifiable through empirical study. Several functional forms of the model were studied for accuracy and exist for different personality types and social circumstances.

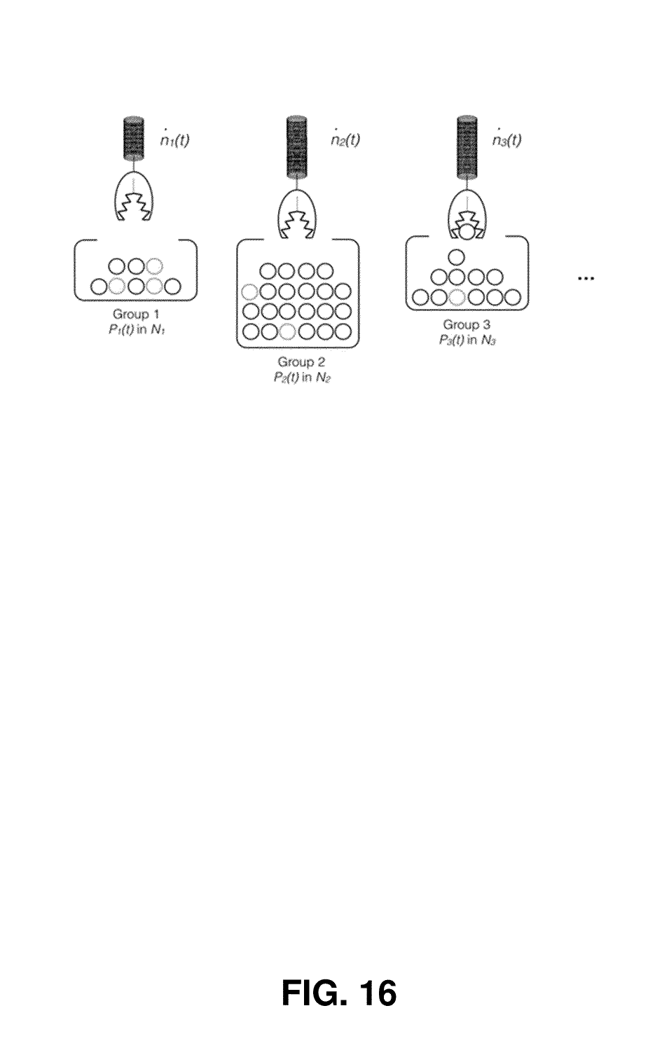

Each (sub)group the user interacts now has a time varying single encounter probability and frequencies of interaction. Now it may be possible to determine a cumulative probability in time of finding a match. This problem may be a modified urn problem FIG. 16 (e.g., A simple toy model for determining the cumulative probability of _nding a match as an urn model. Each urn has a certain total number of balls, of which some fraction, P may be desired. A mechanical arm may be lowered to draw a ball at a rate n_. In the real life case, each group of size Npop has its own single draw probability, Ppop(t), as a function of time along with draw frequency, n_{—} pop(t). Here we assume that replaceability may be irrelevant as Npop>>1. Moreover, the illustration does not incorporate mechanisms for demographic shift within (sub)groups; we acknowledge this exists.) illustrates the problem with a toy model. Notably, results from Example Embodiment may lead to investigating a variation of the Urn problem wherein “mutation” occurs after a selection event. In our case, that would be personality shift as a result of a relationship prior to returning to the original population.

For simplicity, in this paper we assume very large populations. At this limit we consider a binomial distribution for determining cumulative probabilities of finding matches. With such an approach we can determine weighted average single encounter probability across populations as a function of total encounters per group. Here, their time average single encounter probabilities may be appropriate. We can then determine a cumulative probability as a function of time per group using the fractional probability over the normalized sum.

The complexity of the analytical solution increases in cases where groups depart from the large N-limit and in incorporation of user desire to revisit previously rejected and/or failed matches.

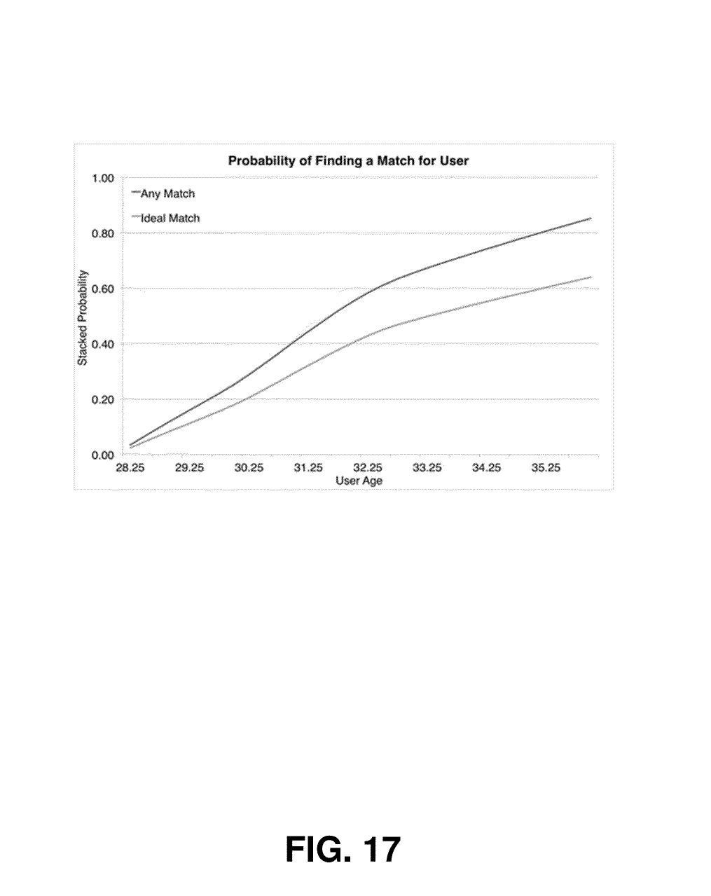

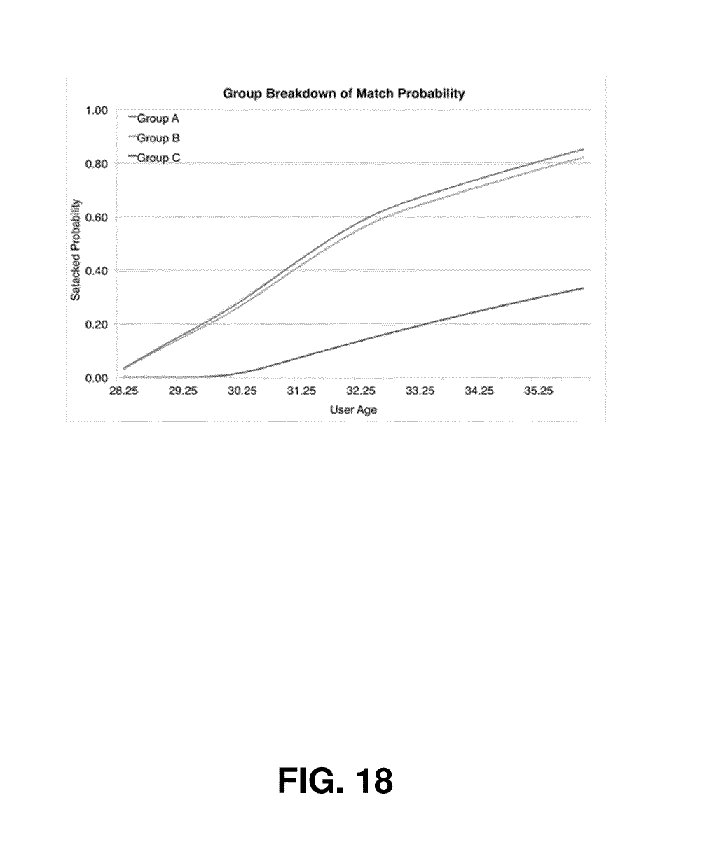

The prototype for the Example Embodiment algorithm was designed for the large N limit and static single encounter probabilities. Thus, we can consider the example of a user and their chances of finding a match in time in this simple case. The prototype integrates results of single draw probability determination for each (sub)group and uses the sociological modeling to determine probabilities of encountering a match. FIGS. 17 and 18 both show the same test case as a stacked probability plot; the sum of the lines show the total probability at that point in time while their relative position shows fraction of the availability probability. In FIG. 17 (e.g., The probability in time of _finding a match for a 28 male year old user as broken down in terms of quality. We define ideal to be of some arbitrary criterion, a function of quality, which may be exclusive of all matches. For example, we note that the interactions of the user in this case study make it likely that most matches will be of ideal quality.) we consider the probability of finding a partner in time as distinguished by quality while in FIG. 18 (e.g., The probability in time of finding a match for a 28 male year old user as broken down in terms of (sub)group of interaction) we distinguish by the group from which a match may be likely found.

Utility Function Valuations

The ultimate purpose of the Example Embodiment algorithm may be to determine the value of romantic options available. We consider there to be three different options: to remain in an existing relationship, to be single with no intention of being in a relationship, and to be single and interested in a relationship of opportunity. To calculate the utility of these options, we consider two functionals. We define functionals to calculate a value of relationships between two individuals and a functional for the value of being single. The units of utility may be arbitrary; it may be in comparison of values between forecasts that we can determine optimal outcomes.

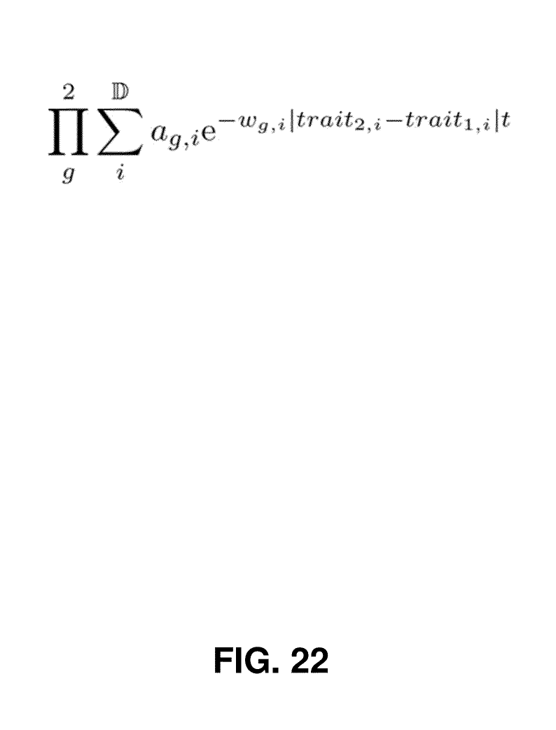

The value of a relationship between two individuals may be derived from a functional that operates in a highly dimensional personality space that may be a function of the traits measured in the psychometric assessment and other values input by the user. Exactly, we assert D>3 may be fundamentally required due to psychological aspects of the problem. Weighted proximity between median user trait desires and partner trait values for both partners for a given trait indicates value of the relationship for that given trait. Equation 1 illustrated in FIG. 22 may be an example of such a function. Naturally, this value may be a function of time wherein a relationship depreciates overtime. In Equation 1 we can tell that relationships depreciate in a compound manner over time.

A system of differential equations over personality space that converges on an equation like Equation 1 may also be constructed which makes it possible to evaluate system stability in time. Naturally, in a subjectively defined, highly dimensional space it may be challenging to draw fundamental insights or conclusions.

Values for specific individuals can be input for such a utility function. In evaluating the utility of \textit{possible} matches we can generate a pseudorandom set of suitors through a Monte Carlo simulation. The personalities of the pseudorandom suitor set may be determined by principle component analysis from the occupied personality space of the subgroups accessible to the user. Therefore we evaluate relationships that may be most probable, not most ideal. This provides realistic forecast as opposed to a wholly randomized one or one that may be overly ideal. We can consider the average and standard deviation of the penalty, wgi, assessed to pseudorandom suitors as compared to a specific individual. In FIG. 18 we compare to a notional girlfriend.

The form of the functional of being single may be based on user personality and direct user response to select questions that indicate user life goals. This indicates what “single space” looks like.

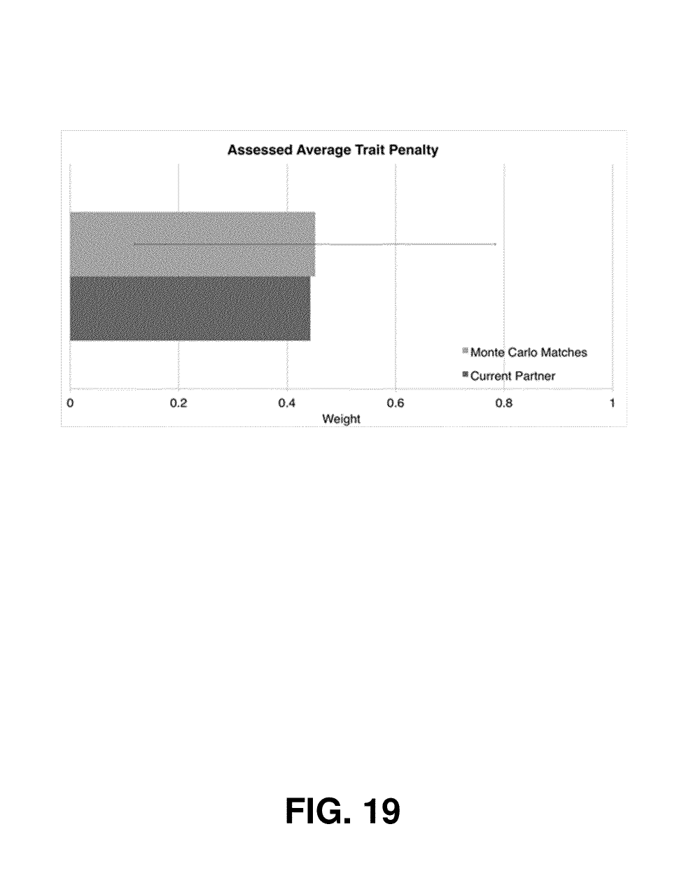

With these two building blocks and through incorporation of cumulative probabilities for each subgroup as determined in the prior step, we can determine the optimal decision for the user given highly personal user context. In all forecasting, errors and other sources of uncertainty may be propagated. In FIG. 19 (e.g., The averaged penalty (e.g. _{—} wg; i across all traits and all Monte Carlo simulation generator suitors as compared to the average penalty of a notional girlfriend) we forecast the value in time of several relationship options; one may be the existing relationship while the other two may be different cases of being single based on location. In this example, the user may remain with his girlfriend despite good odds in FIGS. 17 and 18 of finding another.

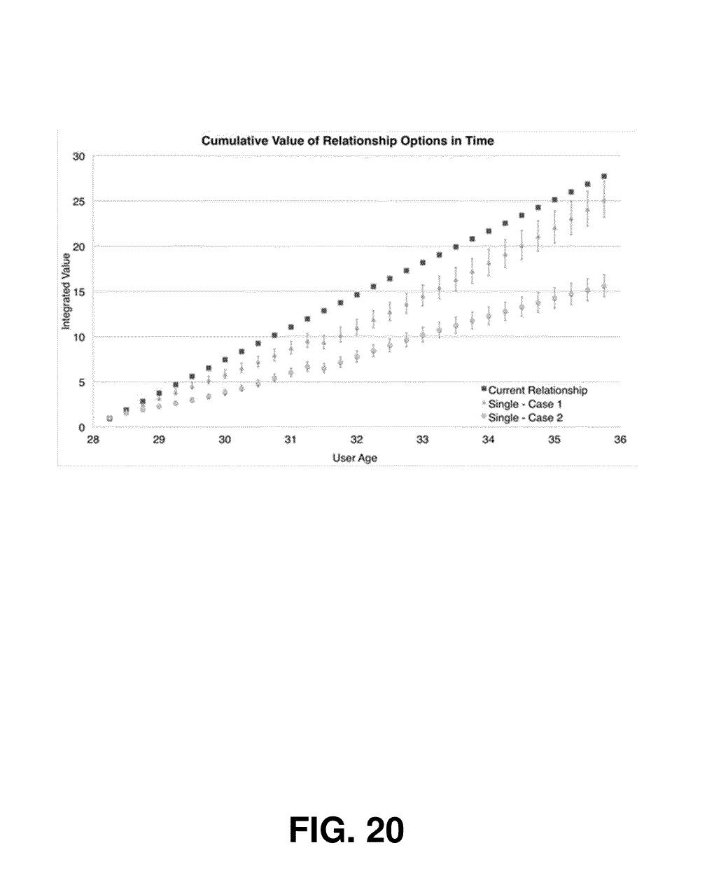

In FIG. 20 (e.g., A new case of a 51 year old single man wherein a previous romantic decision was reaffirmed by algorithm output.) we consider the new case of a 51 year old man who may be currently single having left a relationship in the past. If he were to repeat the relationship, the forecast predicts greater utility in remaining single per his social circumstances.

Reporting

The values determined with the utility functions and cumulative probabilities can be reported to the user for decision making. Additional synthetic metrics or comparison to the existing dataset of users (this need not be personal) can indicate scores of the following to the user: their romantic selectivity, their opportunity for non-romantic social growth, their opportunity to find a match or love, however that may correlate, and if they have a partner, may indicate scores of the quality of their partner as compared to non-failed suitors, and/or whether remaining in a relationship or returning to being single will probably provide maximum utility.

Moreover, the data sets that may be used to derive single encounter probabilities may be also useful in determining ideal subgroups for the user. Results from database queries can be used to determine ideal and worst locations, jobs, demographics, and other subpopulations to best find friends or lovers.

Without a doubt validation may be one of the trickiest parts of long-run forecast models. Thus far, validation efforts have focused on those who have been felt firm in their previous romantic decisions, ideally for several years. This poses issues in evolution of personalities through relationships as well as remembering previous social circumstances. We look forward to on-going validation efforts and methodologies that allow us to reduce the amount of input necessary to the model.

A remaining issue may be incorporation of bisexuality into the algorithm. Non-binary orientation creates considerable complexity as bisexual individuals may not seek identical traits in partners of both genders or value both genders equally. This impacts windows of compatibility, thus single encounter probabilities, and also empirically descriptive utility functions. Therefore theoretical work and continued validation from satisfied bisexuals remains necessary.

A extension for polyamorous relationships may also be developed. Needless to say, moving from a 2- to a 3- or N-body problem may be quite difficult informationally and computationally. Naively, from a non-linear systems perspective we suspect long-term polyamorous outcomes will be chaotic and generally unstable.

### CONCLUSION

Thus, with such an algorithm it may be possible to numerically solve one of mankind's most timeless problems in a consistent and objective manner. Colloquially, we can determine the chances of finding love and where and when it will be found. We can also determine if any given relationship may be worth the time and potential emotional investment.

For individuals who may not be self-certain and lack the access to impartial help, Example Embodiment provides clarity to romantic and social decisions in an unbiased manner. For those who may be in the process of making difficult decisions, Example Embodiment brings objective affirmation. For others, Example Embodiment may be a unique application of systems analysis and mathematical methods that provides remarkably self-consistent and personal results. Beyond the algorithm significant data may be obtained and may be then accessible which can indicate ideal cities, careers, ethnicities for finding friendship or romance through database queries.

We must emphasize the use of “colloquially.” Love may be more than just a number. Despite consistency and objectivity, there may be far more to human relationships than can be put to numbers. Explicitly, there may be many fundamental variables that cannot be understood. In highly dimensional problems with unverifiable initial conditions, it may be challenging to predict an outcome. The Example Embodiment algorithm may be able to reduce this \textit{really hard mathematical problem} into straight-forward, easy-to-understand steps. The point of Example Embodiment may be to bring certainty and affirmation to decision making—not to make a decision for the user. Moreover, the input process itself may be just as valuable for the user than the model results. For many individuals on the cusp of romantic decisions, many questions about life goals and romantic desires have never been formally or externally broached. Example Embodiment provides a neutral and objective medium to ask these questions with minimal priming.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method, comprising:
receiving data corresponding to a first user;
receiving data corresponding to a second user;
receiving data corresponding to a population of users, the population of users comprising one or more users other than the first user and the second user; and
determining a first value corresponding to a relationship between the first user and the second user based upon the data corresponding to the first user, the data corresponding to the second user and the data corresponding to the population of users.

2. The method of claim 1, the receiving the data corresponding to the second user or the receiving the data corresponding to the population of users comprising:
generating data corresponding to a simulated user.

3. The method of claim 1, comprising:
providing one of a first suggestion, a second suggestion, or a third suggestion based upon the first value, the first suggestion corresponding to engaging in the relationship between the first user and the second user, the second suggestion corresponding to disengaging in the relationship between the first user and the second user, the third suggestion corresponding to waiting for a different relationship.

4. The method of claim 1, the determining the first value comprising:
determining a second value based upon a first comparison of the data corresponding to the first user and the data corresponding to the population of users;
determining a third value based upon a second comparison of data corresponding to the second user and the data corresponding to the population of users; and
comparing the second value and the third value to determine the first value.

5. The method of claim 4, comprising:
developing a first time dependent array of values based upon the second value; and
developing a second time dependent array of values based upon the third value.

6. The method of claim 1, the data corresponding to the population of users comprising a first portion and a second portion, the method comprising:
determining a second value based upon a first comparison of data corresponding to the first user and the first portion;
determining a third value based upon a second comparison of data corresponding to the second user and the first portion of the data corresponding to the population of users; and
comparing the second value and the third value to determine the first value.

7. The method of claim 6, comprising:
selecting the first portion based upon input from the first user.

8. The method of claim 1, the determining the first value performed using a normalization technique.

9. A method, comprising:
determining a first variable corresponding to a characteristic of a first user;
determining a second variable corresponding to a characteristic of a second user; and
determining a first value based upon a function using the first variable and the second variable, the first value corresponding to a relationship between the first user and a second user, the first user one of the same as or different than the second user.

10. The method of claim 9, the first value corresponding to a relationship between the first user and a population of users.

11. The method of claim 9, the function comprising at least one of:
a partition function,
a logistic function,
a numerical derivative function,
a polynomial function,
an exponential function, or
an algorithm.

12. A system, comprising:
one or more processing units; and
memory comprising instructions that when executed by at least one of the one or more processing units, perform a method comprising:
receiving data corresponding to a first user;
receiving data corresponding to a second user;
receiving data corresponding to a population of users, the population of users comprising one or more users other than the first user and the second user; and
determining a first value corresponding to a relationship between the first user and the second user based upon the data corresponding to the first user, the data corresponding to the second user and the data corresponding to the population of users.

13. The system of claim 12, the data corresponding to the first user received from the first user via a website.

14. The system of claim 12, the data corresponding to the second user received from the first user via a website.

15. The system of claim 12, the data corresponding to the second user received from the second user via a website.

16. The system of claim 12, the data corresponding to the second user associated with a simulated user.

17. The system of claim 12, the data corresponding to the population of users received from a database comprising:
values based upon at least one of internet search history, social media, streamed media, surveys, census, or internet purchasing history.

18. The system of claim 12, the data corresponding to the population of users received from a database comprising:
values associated with one or more characteristics of personality comprising at least one of:
an emotional temperament,
a social style,
a cognitive mode,
a physicality,
a relationship skill,
an ethic,
a belief, or
a key experience.

19. The system of claim 12, the data corresponding to the population of users received from a database comprising:
values associated with one or more demographic characteristics.

20. The system of claim 19, the one or more demographic characteristics comprising at least one of:
an age,
a location,
a gender,
a race,
a career field,
a level of education,
a sexual orientation,
a religion,
a culture,
a language,
a political view,
a financial status,
a habit, or
a disability.
